(19) United States
(12) Patent Application Publication
(10) Pub. No.: US 2026/0181351 A1
(43) Pub. Date: Jun. 25, 2026

(54) TECHNIQUE FOR AOI-RELATED EVENT SUBSCRIPTION MANAGEMENT

(71) Applicant: Telefonaktiebolaget LM Ericsson (publ), Stockholm (SE)

(72) Inventors: Emiliano MERINO VAZQUEZ, Madrid (ES); Maria Cruz BARTOLOME RODRIGO, Madrid (ES)

(21) Appl. No.: 19/132,692

(22) PCT Filed: Feb. 7, 2023
(86) PCT No.: PCT/EP2023/052950

§ 371 Date: May 23, 2025

(30) Foreign Application Priority Data
Dec. 27, 2022 (EP) 22383290.8

(51) Int. Cl. H04W 4/021; H04W 8/04; H04W 8/20; H04W 60/04

(52) U.S. Cl. CPC H04W 4/021; H04W 8/04; H04W 8/20; H04W 60/04

(57) ABSTRACT

According to a first aspect, a method of triggering an event subscription-related action for an event indicative of whether a terminal device is served in an AOI is provided. The following steps performed in a core network domain of a mobile communication system: receiving a first event subscription request for the terminal device, the first event subscription request indicating one or more network entities; determining if one of the one or more network entities is registered as a serving network entity for the terminal device; and triggering, dependent on a result of the determination, at least one event subscription-related action for an event indicative of whether a terminal device is served in the AOI.

### TECHNICAL FIELD

The present disclosure generally relates to event subscriptions in a mobile communication system. The technique presented herein can be implemented in the form of methods, computer program products, apparatuses and network systems.

### BACKGROUND

Mobile communication systems can be divided into so-called areas of interest (AOIs). An AOI specifies a geographical portion within a mobile communication system. AOIs can be sub-divided into sub-areas to achieve a finer granularity. Such sub-areas can, for example, be defined to include certain Tracking Areas (TAs), cells, and access nodes (ANs). An AOI can thus be represented by a list of TA identities (TAIs), a set of cell identifiers, certain AN identifiers and so on.

AOIs are flexible tools to implement location-based servicing of terminal devices. For example, the mobile communication system may be configured to provide communication services for certain terminal devices in certain AOIs only. As another example, content providers may offer location-based services for terminal devices being served in a certain AOI. In these examples, a notification is required when a terminal device moves into a certain AOI or leaves that AOI.

Some mobile communication systems provide a subscription-based event notification mechanism that can also be used for configuring AOI notifications. In the following, one such notification mechanism will be described for an exemplary mobile communication system of the 5^{th} Generation (5G) and with reference to the signalling diagram of FIG. 1A.

The network entities involved in the signalling diagram of FIG. 1A comprise an Application Function (AF) 110 operated, for example, by a content provider. Moreover, FIG. 1A illustrates several network entities of a core network domain of the mobile communication system: a network exposure function (NEF) 120, a network repository function (NRF) 130 as well as an access and mobility management function (AMF) 140. The NEF 120 acts as an entry point into the core network domain for the AF 110. The AF 110 thus interacts with the core network domain through the NEF 120. The NRF 130 is a centralized data repository in the core network domain. The AMF 140 handles access as well as mobility for terminal devices. It is configured to serve terminal devices within in a dedicated AOI or a dedicated sub-area thereof.

In step S-100 of FIG. 1A, the AF 110 sends an event subscription request (here: an Nnef_EventExposure_Subscribe message) to the NEF 120. With this event subscription request, the AF 110 subscribes to be notified of a monitoring event of the type “AOI” for a dedicated terminal device “UE-X”. That is, the AF 110 requests to be notified when the terminal device “UE-X” enters (or leaves) the indicated geographical area.

In step S-110, the NEF 120 obtains one or multiple TAIs. To this end, the NEF 120 translates the geographical area indicated by the AF 110 into TAIs. The resulting list of TAIs defines a dedicated AOI corresponding to the geographical area indicated by the AF 110.

In step S-120, for each TAI indicated in the TAI list, sub-steps S-135 and S-140 are performed. In more detail, the NEF 120 needs to identify the one or more AMF(s) 140 that serve the TAIs of the TAI list (i.e., that serve the AOI). To this end, the NEF 120 performs an NRF discovery procedure using as input each TAI obtained in step S-110. The NRF discovery procedure includes sending, in step S-130, an Nnrf_Nfdiscover request to the NRF 130 and receiving, from the NRF 130, an NF discover response in step S-140. The Nnrf_Nfdiscover request includes only a single TAI from the TAI list, in order for the NRF 130 to provide the particular AMF 140 serving the TA having this particular TAI (as the particular AMF 140 may also serve other TAs indicated in the TAI list). In the present example, the NF discover response returns a single AMF 140 (here: “AMF1”) serving the TA with the particular TAI. This NRF discovery process is repeated for each TAI indicated in the TAI list.

In step S-150, the NEF 120 subscribes to each AMF 140 (here: “AMF1”) serving one or more TAIs as indicated in the TAI list. The subscription relates to the same event as that indicated by the AF 110 in step S-100. In more detail, the NEF 120 sends an AOI event subscription message (here: an Namf_EventExposure_Subscribe message), indicating the AOI TAI list determined in step S-110 and the terminal device “UE-X” associated with the description.

In the exemplary signalling diagram of FIG. 1A, it is assumed that the AMF 140 is currently serving the terminal device “UE-X” (see step S-160). In this case, the AOI event subscription procedure works properly as the AMF 140 can store information associated with the subscription message (see step S-150) locally in context information maintained by the AMF 140 for the terminal device “UE-X”.

In the further signalling procedure, the AMF 140 returns, as a confirmation of the subscription message of step S-150, an Namf_EventExposure_Subscribe response in step S-180 to the NEF 120. The NEF 120 forwards this confirmation to the AF 110 in step S-180.

At this point, the AOI event subscription becomes applicable and the AMF 140 triggers AOI event monitoring. Since the terminal device “UE-X” is being served by the AMF 140 in a TA within the AOI, the AOI event is detected in step S-190. The AMF 140 thus provides in step S-195 the requested AOI event notification in an Namf_EventExposure_Notify message to the NEF 120, which forwards this notification in step S-199 to the AF 110. The content of the notification, i.e., “AOI IN”, informs the AF 110 that the terminal device “UE-X” is served in the geographical area indicated by the AF 110 in step S-100.

It has been found that the notification procedure illustrated in the signalling diagram of FIG. 1A does not always work as expected. In particular, there may be malfunctions in case the terminal device is not being served by the AMF 140 when the AMF 140 receives the Namf_EventExposure_Subscribe request (see step S-150 in FIG. 1A). Such malfunctions will now be explained in greater detail with reference to the signalling diagram of FIG. 1B.

Steps S-200 to S-250 of FIG. 1B correspond to steps S-100 to S-150 as described above with reference to FIG. 1A, respectively. In deviation from step S-160, it is determined in step S-260 that the AMF 140 currently does not serve the terminal device “UE-X” for which the AMF 140 has received an AOI event subscription message in step S-250. This also means that the AMF 140 presently does not maintain a context for terminal device “UE-X”, which could be used as a “receptacle” for storing information associated with the AOI event subscription. As a consequence, the AMF 140 returns an error message to the NEF 120 in step S-270.

This also means that the AOI event subscription does not become applicable and the event is not monitored by the AMF 140. In other words, the subscription will fail in the AMF 140 if the AMF 140 is not currently serving the terminal device “UE-X” when a corresponding AOI event subscription message is received in step S-250.

To still make the AOI event subscription at the AMF 140 applicable to terminal device “UE-X”, the AF 110 and the NEF 120 could repeatedly re-attempt to create the subscription, e.g., by periodically re-transmitting the messages in steps S-100/S-200 und S-150/S-250 up to a point in time when the AMF 140 is actually serving the terminal device “UE-X”. Evidently, such an approach would not be a resource-efficient solution.

It has been found that similar problems as described above may occur even in cases in which the AOE event subscription is stored successfully by the AMF 140 in context information maintained for a particular terminal device. In case the terminal device is deregistered from the AMF 140 (e.g., because of an implicit “detach” due to an extended inactivity of the terminal device), the associated context information will however be deleted by the AMF 140. As a result, also the AOI event subscription will be lost. When the terminal device registers back at the AMF 140, the subscription no longer exists and the AOI event will be no longer monitored.

### SUMMARY

There is a need for a technique that avoids one more of the above or other efficient event subscription procedure in an AOI drawbacks, and that enables an context.

According to a first aspect, a method of triggering an event subscription-related action for an event indicative of whether a terminal device is served in an AOI, the method comprising the following steps performed in a core network domain of a mobile communication system: receiving a first event subscription request for the terminal device, the first event subscription request indicating one or more network entities; determining if one of the one or more network entities is registered or registering as a serving network entity for the terminal device; and triggering, dependent on a result of the determination, at least one event subscription-related action for an event indicative of whether a terminal device is served in the AOI.

An event subscription may generally be directed at monitoring, by one network entity, occurrence of a dedicated event and notifying in case of an occurrence another network entity that requested the event subscription.

The method may comprise triggering storing of Information indicated in the first event subscription request in association with subscriber data for the terminal device. The information may be stored in a core network database as part of the subscriber data associated with the terminal device. The subscriber data may also be Indicative of the registered or registering serving network entity and may thus be consulted to determine if one of the one or more network entities Is registered or registering as a serving network entity. The serving network entity may be located in the core network domain and configured to serve the terminal device with respect to one or both of access and mobility.

The first event subscription request may define an applicability of the associated event subscription to the one or more network entities indicated in the first event subscription request. The first event subscription request may define an applicability to network entities that do not have an active event subscription for the terminal device. The at least one subscription-related action may be triggered only if the serving network entity does not have an active event subscription for the terminal device.

If it is determined that one of the one or more network entities indicated in the first event subscription request is registered as the serving network entity, triggering the at least one subscription-related action may comprise sending a second event subscription request to the serving network entity. In this case, the method may further comprise receiving, responsive to the second event subscription request, a first event subscription response and forwarding the first event subscription response, or Information contained therein, to a sender from which the first event subscription request has been received. The received first event subscription response may be Indicative of the terminal device being served in the AOI.

The method may comprise receiving a registration message from a network entity serving the terminal device. In such a case, determining if one of the one or more network entities Indicated in the first event subscription request is registered as a serving network entity for the terminal device may be performed responsive to receipt of the registration message. The method may then further comprise retrieving from a core network database, responsive to receipt of the registration message, event subscription applicability information defining an applicability of an event subscription to the one or more network entities. In such a case the determining step may comprise checking if the network entity from which the registration message has been received matches the event subscription applicability information, wherein the second event subscription request is only sent to the serving network entity in case of a match. The core network database may be one of (i) a unified data repository (UDR) of a 5th Generation-, 5G-, enabled core network domain and (ii) a subscriber profile repository (SPR) or a home subscriber server (HSS) of a 4th Generation-, 4G-, enabled core network domain.

The method may comprise checking if the network entity from which the registration message has been received keeps an active event subscription for the terminal device. The second event subscription request may only be sent to the serving network entity in case no active event subscription is kept.

If it is determined that none of the one or more network entities indicated in the first event subscription request is registered as the serving entity, triggering the at least one subscription-related action may comprise sending a first event subscription response to a sender from which the first event subscription request has been received, wherein the first event subscription response is indicative of none of the one or more network entities indicated in the first event subscription request being registered as the serving entity.

If it is determined that one of the one or more network entities indicated in the first event subscription request is registered as the serving network entity, triggering the at least one subscription-related action may comprise sending a notification to a sender from which the first event subscription request has been received. The method may then comprise retrieving from a core network database, responsive to receipt of the registration message, event subscription applicability information defining an applicability of an event subscription to the one or more network entities.

In such a case, the determining step may comprise checking if the network entity from which the registration message has been received matches the event subscription applicability information, wherein the notification is only sent to the sender in case of a match. The notification may be sent as event notification responsive to the first event subscription request. The method may comprise checking if the network entity from which the registration message has been received keeps an active event subscription for the terminal device. The notification may only be sent to the serving network entity in case no active event subscription is kept.

The event subscription request may be received from an NEF of a 5G-enabled core network domain or a service capability exposure function gateway (SCEF) of a 4G-enabled core network domain. The method may be performed by (i) one of a UDR and UDM 5G-enabled core network domain or (ii) one of a subscriber profile repository (SPR) and a home subscriber server (HSS) 4G-enabled core network domain.

A second aspect relates to a method of handling an event subscription request directed at an event indicative of whether a terminal device is served in an AOI. The method comprises the following steps performed in a core network domain of a mobile communication system: receiving a first event subscription request indicating is the terminal device and the AOI for which an event subscription is requested; determining one or more core network entities serving the AOI; determining event subscription applicability information indicative of the one or more network entities; and triggering an association between the event subscription applicability information and the terminal device indicated in the first event subscription request in a core network database storing subscriber data for the terminal device.

Triggering the association may comprises sending an event subscription request indicative of the terminal device and the event subscription applicability information towards the core network database. The event subscription applicability information may be sent (i) to one of a UDR and a UDM of a 5G-enabled core network domain or (ii) to one of an SPR and an HSS of a 4G-enabled core network domain.

The method of the second aspect may comprise receiving a first event subscription response Indicative of at least one of (i) whether or not one of the one or more network entities is registered as a serving network entity for the terminal device and (ii) whether or not the terminal device is served in the AOI. The first event subscription response may be indicative of the serving network entity. In this case the method may comprise sending a second event subscription request to the serving network entity. The second event subscription request may be indicative of one or more sub-areas comprised by the AOI.

The method of the second aspect may comprise receiving, responsive to the second event subscription request, a second event subscription response from the serving network entity, the second event subscription response including information as to whether the terminal device is served in the AOI. The method may further comprise forwarding the second event subscription response, or the information contained therein, to a sender from which the first event subscription request has been received.

The first event subscription response may indicate that none of the one or more network entities is registered as a serving network entity for the terminal device. In this case, the method of the second aspect may comprise sending, in response to the first event subscription response, a second event subscription response a sender from which the first AOI event subscription request has been received. The method may also comprise receiving, after receipt of the first event subscription response, a notification that one of the one or more network entities is registered as a serving network entity for the terminal device. In such a case, a second event subscription request may be sent to the serving network entity.

The first event subscription request may be received from a server located in a content provider domain. The server may be configured to provide location-based service.

The method of the second aspect may be performed by an NEF of a 5G-enabled core network domain or an SCEF of a 4G-enabled core network domain.

A third aspect relates to a method of sending an event notification for a terminal device served in an AOI, wherein the AOI includes one or more sub-areas. The method comprises the following steps performed by a first network entity in a core network domain of a mobile communication system: receiving a request for an event subscription for a terminal device served by the first network entity, wherein the event subscription request defines one or more sub-areas that are Included in the AOI and served by the first network entity, and wherein the event subscription request is received from a second network entity hosting or interfacing a core network database storing subscriber data for the terminal device; detecting an event related to the terminal device in the context of the event subscription; and sending an event notification Indicative of the detected event to the second network entity and in the event subscription context.

The event may be one of the terminal device being in the AOI and the terminal device not being in the AOI.

The second network entity may be (i) one of a UDR and a UDM of a 5G-enabled core network domain or (ii) one of a SPR and an HSS of a 4G-enabled core network domain. The method may be performed by an AMF of a 5G-enabled core network domain or a mobility management entity (MME) of a 4G-enabled core network domain.

Also provided is a computer program product comprising program code configured to implement the steps of any of the preceding claims when the computer program product is executed on a processor. The computer program product may be stored on a computer-readable recording medium.

A fourth aspect relates to an apparatus for triggering an event subscription-related action for an event indicative of whether a terminal device is served in an AOI, the apparatus being configured to be comprised in a core network domain of a mobile communication system and adapted to: receive a first event subscription request for the terminal device, the first event subscription request indicating one or more network entities; determine if one of the one or more network entities is registered or registering as a serving network entity for the terminal device; and trigger, dependent on a result of the determination, at least one event subscription-related action for an event indicative of whether a terminal device is served in the AOI.

The apparatus of the fourth aspect may be adapted to perform the method of the first aspect.

A fifth aspect relates to an apparatus for handling an event subscription request directed at an event indicative of whether a terminal device is served in an AOI, the apparatus being configured to be comprised in a core network domain of a mobile communication system and adapted to: receive a first event subscription request indicating the terminal device and the AOI for which an event subscription is requested; determine one or more core network entities serving the AOI; determine event subscription applicability information indicative of the one or more network entities; and trigger an association between the event subscription applicability information and the terminal device Indicated in the first event subscription request in a core network database storing subscriber data for the terminal device.

The apparatus of the fifth aspect may be adapted to perform the method of the second aspect.

A sixth aspect relates to an apparatus of sending an event notification for a terminal device served in an AOI, wherein the AOI includes one or more sub-areas, the apparatus being comprised by a first network entity in a core network domain of a mobile communication system and adapted to: receive a request for an event subscription for a terminal device served by the first network entity, wherein the AOI event subscription request defines one or more sub-areas that are included in the AOI and served by the first network entity, and wherein the event subscription request is received from a second network entity hosting or interfacing a core network database storing subscriber data for the terminal device; detect an event related to the terminal device in the context of the event subscription; and send an event notification Indicative of the detected event to the second network entity and in the event subscription context.

The apparatus of the sixth aspect may be adapted to perform the method of the third aspect.

Also provided is a network system comprising two or more of the triggering apparatus of the fourth aspect, the handling apparatus of the fifth aspect and the sending apparatus of the sixth aspect.

### BRIEF DESCRIPTION OF THE DRAWINGS

Further aspects, details and advantages of the present disclosure will become apparent from the detailed description of exemplary embodiments below and from the drawings, wherein:

FIG. 1A is a signalling diagram Illustrating a successful AOI event subscription;

FIG. 1B is a signalling diagram illustrating a non-successful AOI event subscription;

FIGS. 2 & 3 are block diagrams Illustrating a system and apparatus realizations of the present disclosure;

FIGS. 4A to C are flow diagrams Illustrating method realizations of the present disclosure;

FIGS. 5A to D are signalling diagrams illustrating further realizations of the present disclosure; and

FIGS. 6A to D are signalling diagrams illustrating still further realizations of the present disclosure.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

While, for example, the following description focuses on an exemplary core network configuration in accordance with 5G specifications, the present disclosure is not limited in this regard. The present disclosure could, for example, also be implemented in other mobile communication systems having a core network domain complying with 4G specifications or beyond-5G specifications.

Those skilled in the art will further appreciate that the steps, services and functions explained herein may be implemented using individual hardware circuits, using software functioning in conjunction with a programmed processor or general purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that control the one or more processors to perform the steps, services and functions disclosed herein when executed by one or more processors.

In the following description of exemplary realizations of the present disclosure, the same reference numerals denote the same or similar components.

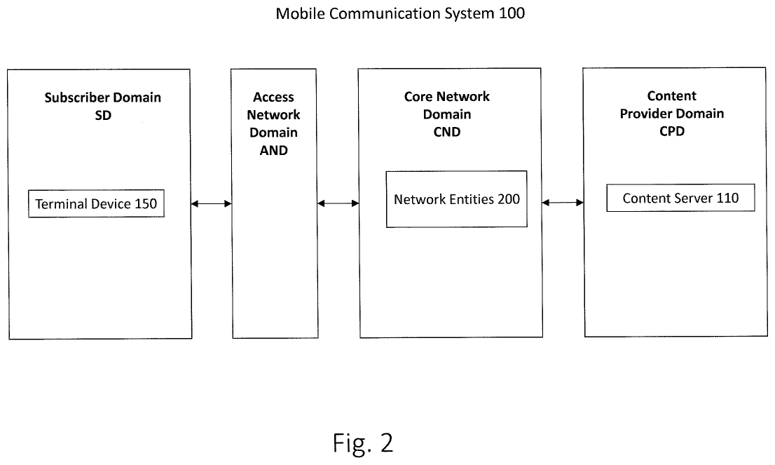

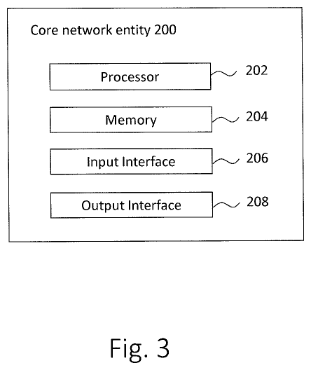

FIG. 2 illustrates an embodiment of a mobile communication system 100 in which the present disclosure can be realized. The mobile communication system 100 may be configured as a subscription-based cellular communication network operated by a mobile network operator (MNO).

As shown in FIG. 2, the mobile communication system 100 comprises a content provider domain (CPD) configured to provide digital content to a subscriber domain (SD). The system 100 further comprises a core network domain (CND) and an access network domain (AND) functionally arranged between the CPD and the SD. In some variants, at least the CND and the AND are split into a user plane for transporting application traffic (e.g., digital content) and a control plane for transporting control signalling. As understood herein, a particular domain comprises one or more devices, nodes or functions under control of a particular domain owner, such as a subscriber, an MNO or a content provider.

The CND and the AND each comprises one or more network entitles, such as network nodes or network functions (NFs). For example, the AND may comprise one or more access points or base stations (not shown) configured to establish one or more wireless communication links to the SD. The CND comprises one or more core network entities 200, such as one or more AMFs, an NEF, an UDR, an UDM, and others.

The SD comprises one or more terminal devices 150 configured to wirelessly communicate with the AND under a subscription regime. Exemplary terminal devices 150 comprise a user equipment- (UE-) type device (e.g., a smartphone, tablet or television set) or an Internet of Things- (IoT-) type device (e.g., a car or a wearable device such as a head-, hand- or body-mounted device) with wireless communication capabilities towards the AND.

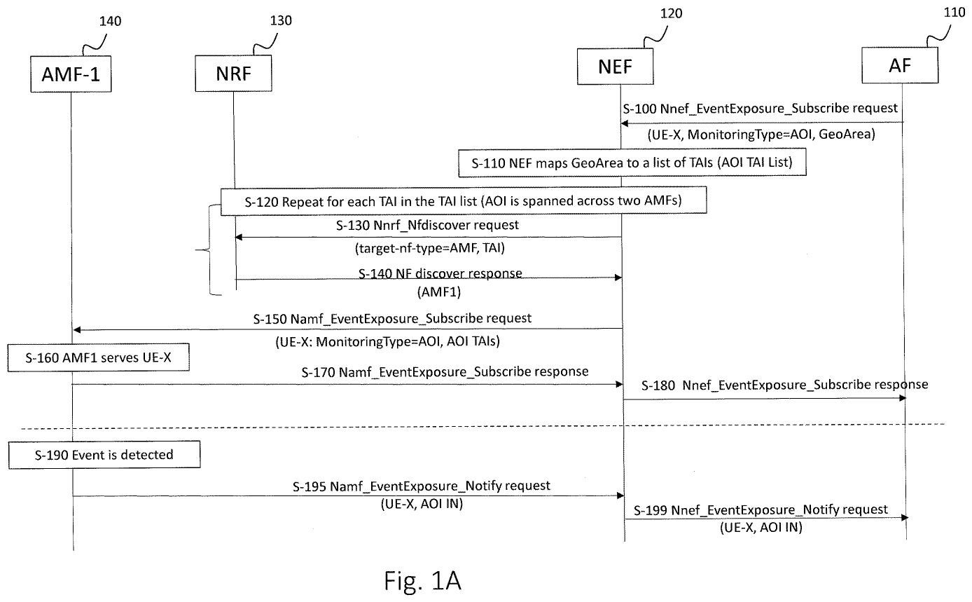

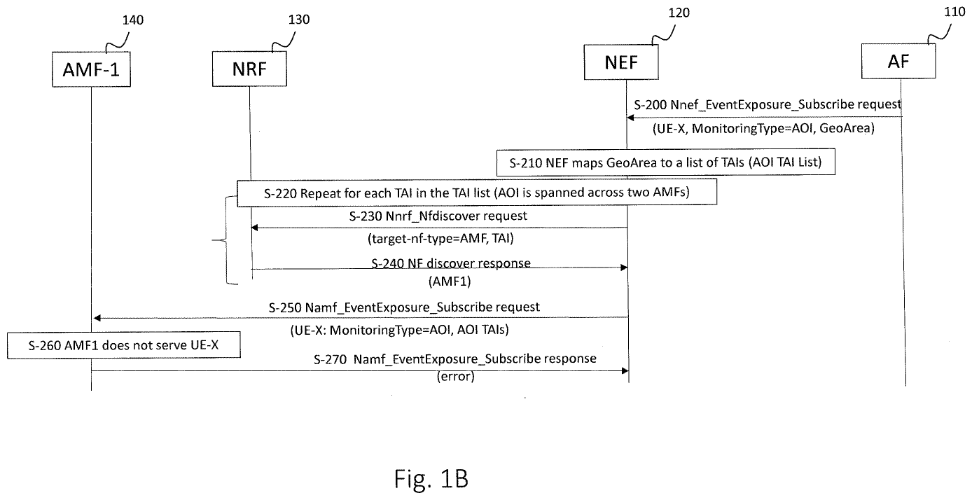

With continued reference to FIG. 2, the system 100 further comprises a content server 110 (e.g., an Internet-based server offering, for example, media download or media streaming services). The content server 110 is located in the CPD and may, e.g., in a 5G scenario, implement the AF of FIGS. 1A and 1B. The content server 110 is in some variants configured to provide location-based services to the one or more terminal devices 150 in the SD. Such location-based services may be limited to a certain geographical area.

Exemplary realizations of the core network entities 200 illustrated in FIG. 2 will now be explained with reference to FIG. 3. As Illustrated in FIG. 3, in one exemplary hardware implementation, each of the entities 200 comprises a processor 202 and a memory 204 coupled to the processor 202. The memory 204 stores program code that controls operation of the processor 202 to implement one or more aspects of the present disclosure. As understood herein, the processor 202 may be realized using any processing circuitry and is not limited to, for example, a single, localized processing core but may, for example, also have a distributed (e.g., cloud-based) topology. Each of the entities 200 further comprises an optional input interface 206 and an optional output interface 208 for communication with other entitles in the CND or outside the CND.

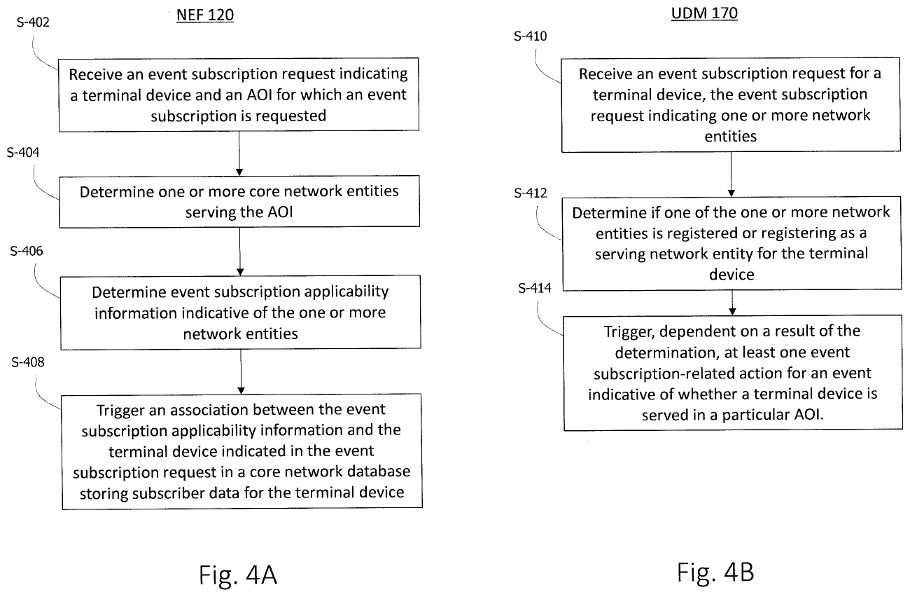

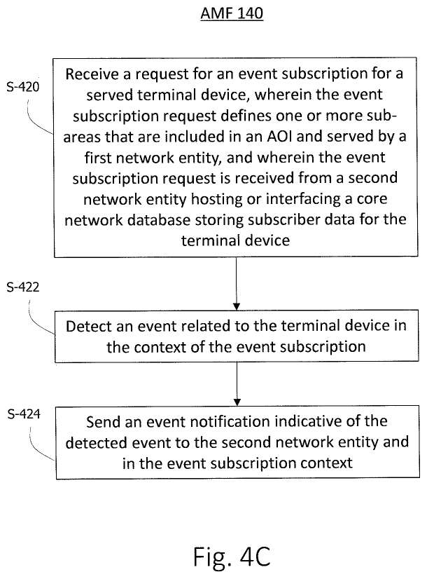

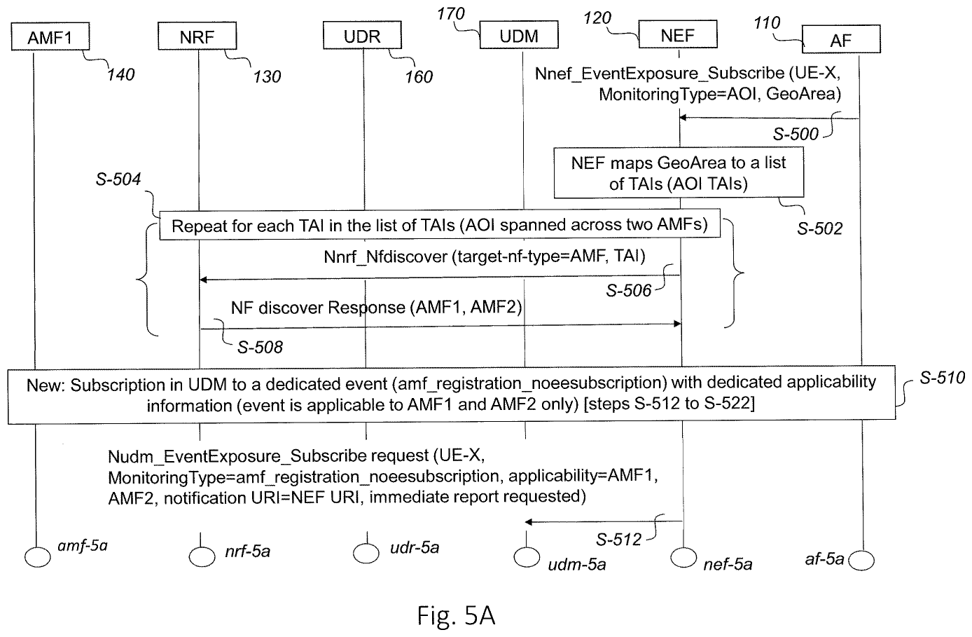

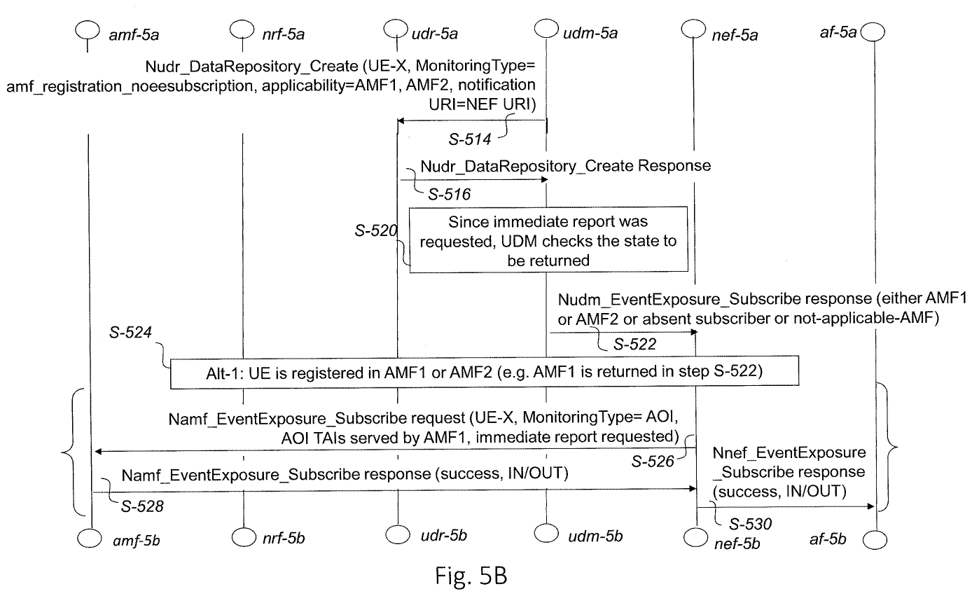

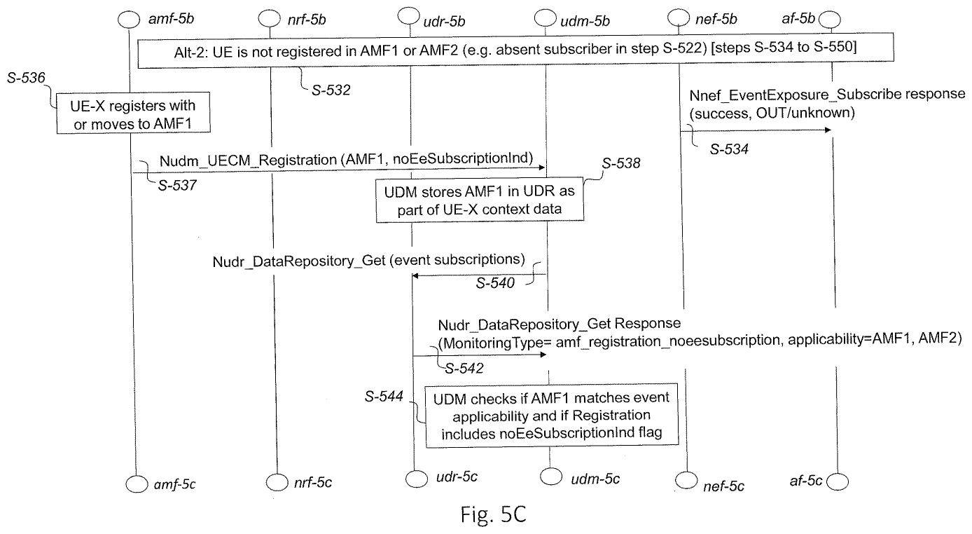

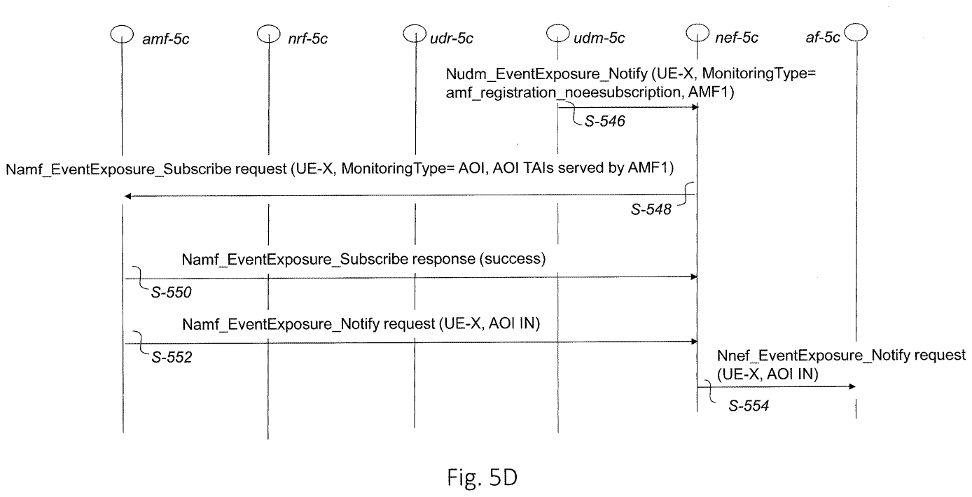

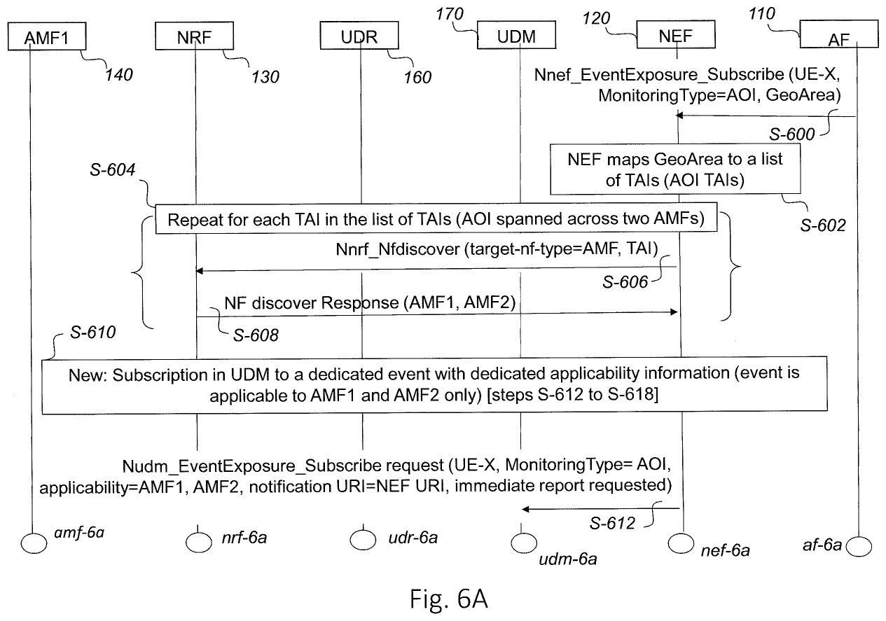

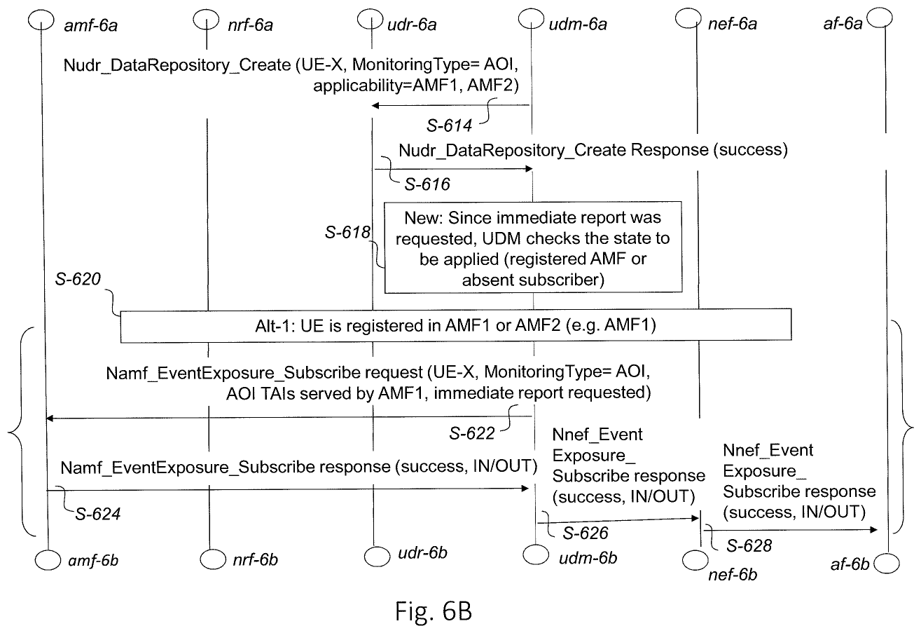

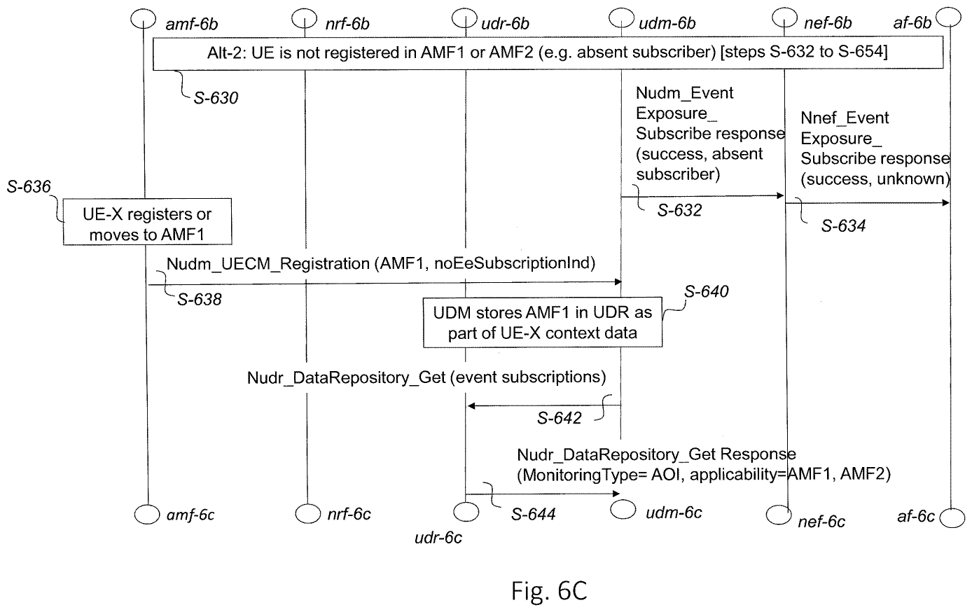

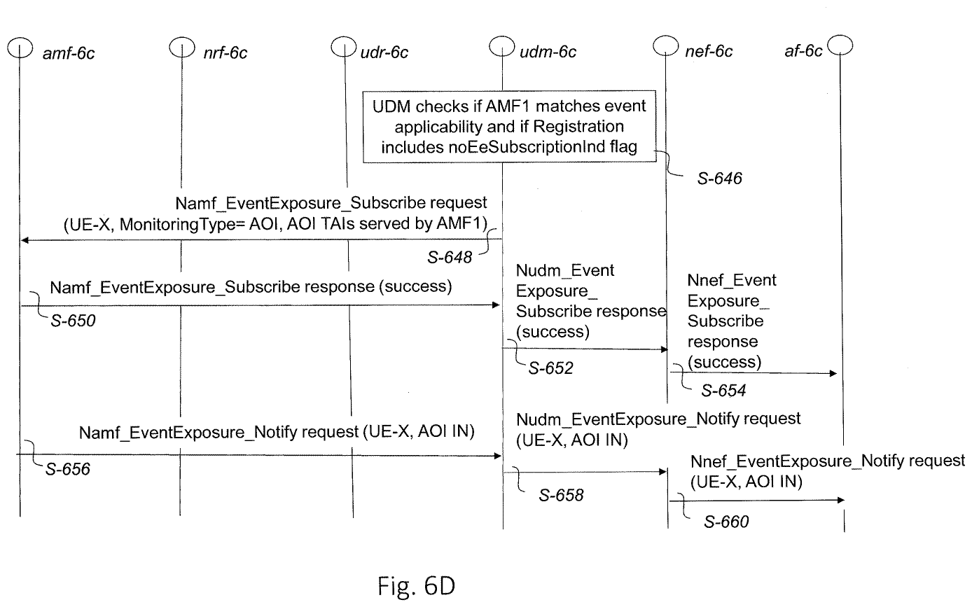

In the following description, an exemplary 5G realization implementing aspects of the present disclosure will be described with reference to the flow diagrams of FIGS. 4A to 4C and the signalling diagrams of FIGS. 5A to 5D and 6A to 6D. It will be apparent to one skilled in the art that similar signalling realizations will apply in case of a 4G or a combined 4G/5G implementation.

Compared to the signalling diagrams of FIGS. 1A and 1B, the signalling diagrams of FIGS. 5A to 5D and 6A to 6D further illustrate a UDR 160 and a UDM 170. The UDM 170 centrally handles data (in particular subscriber data) in the CND. To this end, the UDM 170 hosts or has access to the UDR 160 that, in turn, hosts a subscriber database. The UDM 170 itself may store session context information for later retrieval when a session is created. Some NFs may access the UDR 160 directly and some only via the UDM 170.

3GPP TS 23.501 V15.4.0 (2018-12) and later defines architectural aspects of a 5G service based architecture (SBA). According to this SBA, NFs use service-based Interactions to consume services from other NFs. The discovery of services and of NFs producing them is provided by the NRF 130. Service producing NFs register, update or deregister their profiles in the NRF 130. Service consuming NFs discover services offered by NF producer instances by querying the NRF 130 about NF Instances offering services of a given type. NFs may subscribe and unsubscribe to changes in the status of NFs registered in the NRF 130. Based on such subscriptions, the NRF 130 or other NFs may notify subscriber NFs of local status changes. This subscription framework is utilized in the context of the following embodiments for triggering event-related actions.

For better understanding of the solutions discussed hereinafter, reference is made to 3GPP TS 29.522 V.17.5.0, TS 29.122 V.17.5.0 and TS 29.503 V.17.6.0.

In the context of the signalling diagrams of FIGS. 5A to 5D and 6A to 6D two possible solutions are described that enable an efficient event subscription procedure in an AOI context (e.g., for the provision of location-based services). These solutions avoid some or all of the drawbacks discussed above with reference to signalling diagram of FIG. 11.

The solution of FIGS. 5A to 5D comprises a subscription to UDM 170 for a new CND-Internal event detected and reported by UDM 170. In FIGS. 5A to 5D, this new event subscription is designated as “AMF_REGISTRATION_NOEESUBSCRIPTION”. The new to event subscription includes a particular event subscription applicability concept (to one or multiple AMFs 140 that serve the AOI).

The UDM 170 identifies when the event occurs. In the scenario of FIGS. 5A to 5D there are two conditions for the event to occur for a particular terminal device 150. First, the terminal device 150 is to be served by an AMF 140 matching one of the AMFs that serve the AOI. Second, in the registration to the UDM 170, the AMF 140 includes the noEeSubscriptionInd flag (indicating that this AMF 140 does not hold Event Exposure subscription data). Then, the AMF 140 that serves this terminal device 150 receives a corresponding AOI event subscription request. In more detail, if the event applies, the UDM 150 notifies the associated NEF 120 from which the initial subscription request (“AMF_REGISTRATION_NOEESUBSCRIPTION”) was received, and the NEF 120 then performs a “regular” AOI event subscription to the AMF 140.

The solution of FIGS. 6A to 6D comprise defining support of an AOI event subscription in the UDM event exposure service (note that, currently, the UDM 170 does not support a subscription to this event), with an enhancement of the AOI event subscription towards UDM 170, that includes a new applicability concept (to one or multiple AMFs that serve the AOI). The UDM 170 then has the possibility to authorize the event for the requested terminal device 170.

In more detail, the UDM 170 identifies the same situation as in the solution of FIGS. 5A to 5D, namely (1) that a terminal device 170 is to be served by an AMF 140 matching one of the AMFs that serve the AOI and (2) that in its registration to UDM 170 the AMF 140 includes the noEeSubscriptionInd flag (indicating that this AMF 140 does not hold Event Exposure subscription data). In this case, it is UDM 170 that sends directly the AOI event subscription request to the AMF 140 (on behalf of the NEF 120, so to say).

Both solutions are based on a subscription to the UDM 170, that is then persisted in the UDR 160. So in both solutions, the internal event subscription (“AMF_REGISTRATION_NOEESUBSCRIPTION”) of FIGS. 5A to 5D and the AOI event subscription of FIGS. 6A to 6D are both known by any UDM 170 when required (i.e., when receiving a registration message from an AMF 140 serving a particular terminal device 150).

Referring now to FIGS. 4A and 5A, the procedure starts with the NEF 120 receiving an AOI event subscription request from the AF 110 (“Nnef_EventExposure_Subscribe request”) in steps S-402 and S-500. This request Indicates a particular terminal device (“UE-X”) and a particular AOI (defined by a geographical area “GeoArea” in this example, such as a certain city or a part thereof) for which an AOI event notification is requested. The AF 110 may use such AOI event notifications to provide is a location-based service to the terminal device UE-X.

In step S-404 of FIG. 4A, the NEF 120 determines one or more core network entities (i.e., AMFs 140) serving one or more sub-areas included in the AOI (each sub-area may be served by one or more AMFs 140). To this end, the NEF 120 first maps the AOI to one or multiple TAIs, as illustrated by step S-502 of FIG. 5A. In this way, a list of TAIs is obtained that correspond to the AOI. Each TAI is indicative of a sub-area of the AOI. In a second step, the NEF 120 identifies the one or more AMFs 140 serving the TAs associated with these TAIs by looking up for each TAI in the TAI list (step S-504 in FIG. 5A) the AMF 140 serving this TA (steps S-506 and S-508 in FIG. 5A). In more detail, the NEF 120 in step S-506 sends an Nnrf_Nfdiscover request for a given TAI (with the NF type indication “AMF”) to the NRF 130 and receives, in step-S-508, an NF discover response with the associated one or more AMFs from the NRF 130.

In the example of FIG. 5A, it is assumed that the TA corresponding to the TAI signalled to the NRF 130 in step S-506 is served by two AMFs 1401, 1402. In other variants, only one AMF 140 may serve a given TA. Each AMF 140 may in principle be related to one or multiple TAIs from the TAI list. From the result obtained in steps S-404 and S-506/S-508, the NEF 120 determines, in step S-406, event subscription applicability information Indicative of the AMFs obtained in the procedure of step S-504. In certain variants the applicability information may indicate, for each of one or more AMFs 140, one or more sub-areas of the AOI (in terms of TAIs) served by and, thus associated with, the respective AMF 140. As an example, the event subscription applicability information can take the form of a list of AMFs or the form of a mapping of the AOI TAIs to one or multiple AMFs 140. In the mapping, for each AMF 140 one of multiple TAIs served by this AMF may be indicated. Of course, the event subscription applicability information may also have other formats or contents.

Then, in step S-408, the NEF 120 triggers an association between the event subscription applicability Information and the terminal device “UE-X” Indicated in the event subscription request received in step S-402/S-500. The association is triggered in the UDR 160, i.e., In a core network database storing subscriber data for the terminal device “UE-X” (and other terminal devices 150) as will now be described in more detail.

As Indicated by a procedure indicated as S-510, the association between the event subscription applicability information and the terminal device “UE-X” is triggered in the context of a subscription to the UDM 170 for a dedicated event is (“AMF_REGISTRATION_NOEESUBSCRIPTION”) with dedicated applicability information (event Is applicable to AMF1 and AMF2 only). This procedure comprises steps S-512 to S-522.

In step S-512, the NEF 120 sends an Event Exposure (EE) subscription to the UDM 170 with a new event of the monitoring type “AMF_REGISTRATION_NOEESUBSCRIPTION” (see also step S-410 in FIG. 4B). The associated event subscription request (Nudm_EventExposure_Subscribe request) Includes an Indication of an applicability for this event (i.e., the event subscription applicability Information discussed above with respect to AMF1 and AMF2). In general, applicability information may indicate multiple AMFs (each possibly associated with one or multiple TAIs defining the AOI). The event subscription request also identifies the terminal device “UE-X” as well as the NEF 120 that is to be notified in case the event is detected. Therefore, the event will be detected when the UDM 170 identifies that terminal device “UE-X” is to be served by one of the AMFs that is defined in the applicability information (i.e., by one of the AMFs obtained previously that provide service to the AOI), but only when the noEeSubscriptionInd flag is included in the registration message (Nudm_UECM_Registration) from the corresponding AMF. This flag indicates that this AMF does not keep any EventExposure Subscription data, meaning that such data have never been created or were removed when the terminal device context was removed in the AMF (e.g., when the terminal device “UE-X” moved to another AMF). In the event subscription request sent in step S-512, “immediate reporting” is requested.

In steps S-514 and S-516, the subscription with the applicability information is stored in the UDR 160 in association with (e.g., in) the subscriber data for terminal device “UE-X” (step S-408), and this is confirmed by the UDR 160 to the UDM 170. This storing step solves the problem of the subscription in AMF 140 getting lost when the terminal device “UE-X” moves from this AMF 140 to another AMF (resulting in a deletion of the associated device context by AMF 140). The subscription in UDR 160 is made persistent. The UDR 160 thus stores the subscription for the monitoring type “AMF_REGISTRATION_NOEESUBSCRIPTION” with the associated event subscription applicability information.

Since Immediate reporting was requested (step S-512), the UDM 170 in step S-520 checks the information to be included in an upcoming subscription response to the NEF 120 and triggers, dependent on a result of the check, an AOI event subscription-related action (see also step S-414 in FIG. 4B). In more detail, the UDM 170 checks 1s the subscriber data for terminal device “UE-X” for the serving AMF 140 that may be registered itself earlier (Nudm_UECM_Registration). If it is determined in the context of the present solution that the terminal device “UE-X” Is served either by AMF1 or AMF2 (i.e., that either AMF1 or AMF2 is registered as serving network entity, see also step S-412 in FIG. 4B), then the registered AMF (i.e., either AMF1 or AMF2) is returned in the subscription response of step S-522. Alternatively, if the terminal device “UE-X” is marked as “purged” (e.g., if there is no serving AMF 140 for the user terminal “UE-X”), then “unknown” is Indicated in the subscription response. Otherwise, if the terminal device “UE-X” is registered in another AMF3 that does not provide service to the AOI, then “not-applicable-AMF” or “absent subscriber” Is returned to the NEF 120.

Depending on the outcome of the check performed in step S-520 and the content of the subscription response in step S-522, the NEF 120 will proceed in different ways. If, as a first alternative, it is determined that terminal device “UE-X” is registered in an AMF 140 matching the AMF list provided by the NEF 120 as applicability Information (in this example AMF-1 or AMF-2, see step S-524), the method proceeds with step S-526. In step S-526, the NEF 120 sends an AOI event subscription request to the AMF 140 that was indicated in the message received by the NEF 120 in step S-522. This AOI event subscription-related action was triggered by the UDM 170 with step S-522 (see also step S-414 in FIG. 4B).

The subscription request pertains to the AOI event for the terminal device “UE-X” and includes the one or more TAIs of the one or more TAs in the AOI that this AMF 140 serves (as obtained in steps S-504 to S-506). Immediate reporting is requested (this is possible in this case since a subscription response has not been provided yet to the AF 110). The AMF 140 (here: AMF1) can successfully create the subscription (since the terminal device context for terminal device “UE-X” exists in AMF1). Since immediate reporting was requested, the AMF 140 provides a subscription response in step S-528 that includes a reporting result pertaining to the terminal device “UE-X” and the AOI. The result can be “IN” if the terminal device “UE-X” is in a TA that is within the AOI, while it would be “OUT” if the terminal device “UE-X” is in a TA that is not within the AOI (note that the AMF 140 may provide service to multiple TAs, and some of them may not be within the AOI).

In step S-530, the subscription response from the AMF 140 (in more detail: the Information on the AOI-related result contained therein) is forwarded by the NEF 120 to the AF 110. The AF 110 may then start providing location-based services to the is terminal device “UE-X” in case the terminal device “UE-X” Is in the AOI.

As stated above, depending on the outcome of the check performed in step S-520 and the content of the subscription response in step S-522, the NEF 120 will proceed in different ways. As a second alternative (see S-532 in FIG. 5C), it may be determined that the terminal device “UE-X” is not registered in an AMF 140 matching the AMF list provided by the NEF 120 as applicability information (in this example AMF-1 or AMF-2, see step S-524). For example, the UDM 170 may have returned “absent subscriber” in step S-522.

In such a scenario, the NEF 120 cannot send a subscription request to any AMF 140 since the terminal device “UE-X” is not in any applicable AMF 140 for the AOI. A corresponding subscription response is thus sent in step S-534 to the AF 110. The Information provided in the subscription response will be “unknown” if the terminal device “UE-X” is marked as “purged” (its location is unknown), while otherwise the result will be OUT.

The method continues when the terminal device “UE-X” registers in an AMF 140 (here: AMF1) or moves to an AMF 140 (here: AMF1), see step S-536. The AMF 140 will register at the UDM 170 with a Nudm_UECM_Registration message, see step S-537. This message identifies the AMF 140 (as AMF1) and includes a noEeSubscriptionInd flag. This flag Indicates that AMF1 does not have any Event Exposure (EE) subscription (this is the case, e.g., when the terminal device “UE-X” performs an initial registration in AMF1 or moves to AMF1 from EPS/MME).

In step S-536, the UDM 170 stores the serving AMF 140 (here: AMF1) in the UDR 160 as part of the context data held for terminal device “UE-X” (i.e., in association with the subscriber data held for the terminal device “UE-X”).

In the context of the solution presented herein, the UDM 170 checks event subscriptions to the event=“AMF_REGISTRATION_NOEESUBSCRIPTION”. To this end, the UDM 170 retrieves subscription information from the UDR 160 (steps S-540 and S-542). The UDM 170 then determines in step S-544, based on the retrieved subscription information and the content of the registration message received in step S-537, if the event actually occurs. Since the UDM 170 can determine that the registering AMF 140 (here: AMF1) matches the event applicability information (as received in step S-542), i.e., that the terminal device “UE-X” is served by AMF1 (see step S-412 in FIG. 4B), and that the registration request (step S-537) from the AMF 140 included the flag noEeSubscriptionInd, the event “AMF_REGISTRATION_NOEESUBSCRIPTION” is triggered. As a result, the UDM 170 sends an event exposure notification to the NEF 120, see step S-546 of FIG. 5D and step S-414 in FIG. 4B.

In response to this notification, the NEF 120 sends an AOI event subscription request to the AMF 140 (here: AMF1) in step S-548. This AOI event subscription-related action was triggered by the UDM 170 with step S-546 (see also step S-414 in FIG. 4B). Similar as in step S-526, the subscription request Includes the AOI TAIs for this AMF 140. The TAIs have possibly been obtained in step S-542 (e.g., when also conveyed in steps S-512 and S-514). Deviating from step S-526, an “Immediate report” is not requested, since a response has already been provided to the AF 110 (step S-534).

The AMF 140 can successfully store the AOI event subscription in the locally maintained context information for the terminal device “UE-X”, and a corresponding subscription response is provided to the NEF 120 in step S-550. Under the AOI event subscription, the AMF 140 will monitor the AOI event and determine whether a corresponding notification needs to be sent for the terminal device “UE-X”. For example, the AMF 140 sends a corresponding notification in step S-552 to the NEF 120 to inform the NEF 120 that the terminal device “UE-X” is in the AOI. The NEF 120 then forwards this notification, or the information contained therein, in step S-554 to the AF 110. The AF 110 may then start providing location-based services to terminal device “UE-X”.

As has been explained above, the solution of FIGS. 5A to 5D comprises a subscription to UDM 170 for the event (“AMF_REGISTRATION_NOEESUBSCRIPTION”) detected and reported by UDM 170. The solution that will now be described with reference to FIGS. 6A to 6D comprise defining support of an AOI event subscription in the UDM event exposure service, with an enhancement of the AOI event subscription towards UDM 170. In more detail, the UDM 170 identifies the same situation as in the solution of FIGS. 5A to 5D, namely (1) that a terminal device 170 is to be served by an AMF 140 matching one of the AMFs that serve the AOI and (2) that in Its registration to UDM 170 the AMF 140 includes the noEeSubscriptionInd flag. In this case, it is UDM 170 that sends directly the AOI event subscription request to the AMF 140.

Steps S-600 to S-608 of FIG. 6A correspond to steps S-500 to S-508 of FIG. 5A. Also is some of the further steps discussed below correspond to related steps in FIGS. 5A to 5D and will therefore not be discussed in greater detail.

In the procedure indicated by S-610, the NEF 120 subscribes to the UDM 170 for an enhanced AOI event. To this end, the NEF 120 in step S-612 sends an AOI event subscription request to the UDM 170 (see also step S-410 in FIG. 4B). As an enhancement, the subscription request includes event applicability information defining that the event shall be applicable to AMF1 and AMF2 (similar as discussed above with reference to step S-512). Also, the TAIs associated with each of AMF1 and AMF2 may be communicated in the subscription request as part of the applicability information. Moreover, immediate reporting is requested.

In steps S-614 and S-616 (similar to steps S-514 and 516), the subscription is stored in the UDR 160 (see also step S-408 in FIG. 4A), including the indication of applicability in terms of AMF1 and AMF2 (and, optionally, the associated TAIs). Then, in step S-618 (similar to step S-520), and since immediate reporting was requested, the UDM 170 checks the current status of terminal device “UE-X”. In particular, the UDM 170 checks if in the subscriber data for terminal device “UE-X”, any of AMF1 and AMF2 Is registered as the serving AMF 140 (see step S-412 in FIG. 4B).

Depending on the outcome of the check performed in step S-618, the UDM 170 will proceed in different ways. If, as a first alternative, it is determined that terminal device “UE-X” is registered in an AMF 140 matching the AMF list provided by the NEF 120 as applicability information (in this example AMF-1 or AMF-2 and, optionally, the associated TAIs), the method proceeds with procedure S-620. In step S-622 of this procedure, the UDM 170 sends an AOI event subscription request to this AMF 140 (see also step S-420 of FIG. 4C). The subscription request pertains to the AOI event for the terminal device “UE-X” and includes the TAIs in the AOI that this AMF 140 serves (as received in step S-612). Immediate reporting is requested.

Since immediate reporting is requested, the AMF 140 in step S-624 provides a subscription response with the requested information. The requested information will be “IN” if the terminal device “UE-X” Is in a TA of the AOI, otherwise it will be “OUT”. In step S-626, the UDM 170 forward the subscription response to the NEF 120, which forwards it in step S-628 to the AF 110. The AF 110 may then provide location-based services to the terminal device “UE-X” depending on the whether or not the terminal device “UE-X” Is in the AOI.

As stated above, depending on the outcome of the check performed in step S-618, the UDM 170 will proceed in different ways. As a second alternative (see procedure S-630 in FIG. 6C), it may be determined that the terminal device “UE-X” is not registered in an AMF 140 matching the applicability information (in this example AMF-1 or AMF-2). For example, the UDM 170 may have determined the status “absent subscriber” in step S-618.

Since the terminal device “UE-X” is not within the AOI, the UDM 170 cannot send an AOI event subscription request to an AMF 140 as it step S-622. Rather, it provides a subscription response to the NEF 120, indicating “absent subscriber” (step S-632). The NEF 120 is able to interpret the “absent subscriber” indication as “unknown” (in other words, it cannot be inferred if the terminal device “UE-X” is either “IN” or “OUT”). The NEF 120 forwards this information (i.e., “unknown subscriber”) in step S-634 as a subscription response to the AF 110.

Steps S-636 to S-646 are again similar to steps S-536 to S-544 discussed above with reference to FIGS. 5C and 5D. One difference resides in the fact that in step S-542, the event subscription information retrieved by the UDM 170 relates to the enhanced AOI event subscription, instead of the “AMF_REGISTRATION_NOEESUBSCRIPTION”.

In step S-648, the NEF 120 sends an AOI event subscription request to the AMF 140 (here: AMF1). Similar as in step S-626, the subscription request includes the AOI TAIs for this AMF 140. Deviating from step S-626, an “immediate report” is not requested, since a response has already been provided to the AF 110.

The AMF 140 can successfully store the AOI event subscription in the locally maintained context information for the terminal device “UE-X”, and a corresponding subscription response is provided to the UDM 170 in step S-650 and forwarded, via the NEF 120 (step S-652), to the AF 110 (step 654). Under the AOI event subscription, the AMF 140 will monitor the AOI event and detect if the event occurs (see step S-422 of FIG. 4C) and if a corresponding notification needs to be sent for the terminal device “UE-X” in the applicable event subscription context. For example, the AMF 140 sends a corresponding notification in step S-656 to the UDM 170 to inform the UDM 170 that the terminal device “UE-X” is in the AOI (see step S-424 of FIG. 4C). The UDM 170 then forwards this notification, or the information contained therein, via the NEF 120 (step S-658) to the AF 110 (step S-660). The AF 110 may then start providing location-based services to terminal device “UE-X”.

As has become apparent from the above description of exemplary embodiments, the technique presented herein overcomes one or more of the drawbacks discussed above with reference to FIG. 1B. In particular, AOI event subscriptions can also be realized for terminal devices 150 that are presently not served by a particular AMF 140 in a particular sub-area of an AOI of Interest. It is the UDM 170 that in some variants locally takes control. In some variants, the UDM 170 may be involved in authorizing AOI event subscriptions on per a terminal-basis. Such an approach is not possible in the scenarios discussed above with reference to FIGS. 1A and 1B, as the UDM 170 is not involved in the related signalling.

1. A method of triggering an event subscription-related action for an event indicative of whether a terminal device is served in an area of interest, AOI, the method comprising the following steps performed in a core network domain of a mobile communication system:
receiving a first event subscription request for the terminal device, the first event subscription request indicating one or more network entities;
determining if one of the one or more network entities is registered or registering as a serving network entity for the terminal device; and
triggering, dependent on a result of the determination, at least one event subscription-related action for an event indicative of whether a terminal device is served in the AOI.

2. The method of claim 1, further comprising triggering storing of information indicated in the first event subscription request in association with subscriber data for the terminal device.

3. The method of claim 1, wherein the first event subscription request defines an applicability of the associated event subscription to the one or more network entities indicated in the first event subscription request.

4. The method of claim 1, wherein the first event subscription request defines an applicability to network entities that do not have an active event subscription for the terminal device.

5. The method of claim 4, wherein the at least one subscription-related action is triggered only if the serving network entity does not have an active event subscription for the terminal device.

6. The method of claim 1, wherein if it is determined that one of the one or more network entities indicated in the first event subscription request is registered as the serving network entity, triggering the at least one subscription-related action comprises sending a second event subscription request to the serving network entity.

7. The method of claim 6, further comprising:
receiving responsive to the second event subscription request, a first event subscription response; and
forwarding the first event subscription response, or information contained therein, to a sender from which the first event subscription request has been received.

8. The method of claim 7, wherein the received first event subscription response is indicative of the terminal device being served in an area of interest.

9. The method of claim 1, further comprising receiving a registration message from a network entity serving the terminal device, wherein determining if one of the one or more network entities indicated in the first event subscription request is registered as a serving network entity for the terminal device is performed responsive to receipt of the registration message.

10. The method of claim comprising
retrieving from a core network database, responsive to receipt of the registration message, event subscription applicability information defining an applicability of an event subscription to the one or more network entities; and wherein
the determining step comprises checking if the network entity from which the registration message has been received matches the event subscription applicability information, wherein the second event subscription request is only sent to the serving network entity in case of a match.

11. The method of claim 10, wherein the core network database is one of (i) a unified data repository, UDR, of a 5th Generation-, 5G-, enabled core network domain and (ii) a subscriber profile repository, SPR, or a home subscriber server, HSS, of a 4th Generation-, 4G-, enabled core network domain.

12. The method of claim 10, further comprising checking if the network entity from which the registration message has been received keeps an active event subscription for the terminal device, wherein the second event subscription request is only sent to the serving network entity in case no active event subscription is kept.

13. The method of claim 1, wherein if it is determined that none of the one or more network entities indicated in the first event subscription request is registered as the serving entity, triggering the at least one subscription-related action comprises sending a first event subscription response to a sender from which the first event subscription request has been received, wherein the first event subscription response is indicative of none of the one or more network entities indicated in the first event subscription request being registered as the serving entity.

14. The method of claim 1, wherein if it is determined that one of the one or more network entities indicated in the first event subscription request is registered as the serving network entity, triggering the at least one subscription-related action comprises sending a notification to a sender from which the first event subscription request has been received.

15.-17. (canceled)

18. The method of claim 1, wherein the event subscription request is received from a network exposure function, NEF, of a 5th Generation- (5 G-) enabled core network domain or a service capability exposure function gateway, SCEF, of a 4th Generation- (4G-) enabled core network domain.

19. The method of claim 1, wherein the method is performed by (i) one of a unified data repository, UDR, and a unified data management, UDM, entity of a 5th Generation-, 5G-, enabled core network domain or (ii) one of a subscriber profile repository, SPR, and a home subscriber server, HSS, of a 4th Generation-, 4G-, enabled core network domain.

20.-35. (canceled)

36. A computer storage medium storing program code that, when executed on a processor, performs method of triggering an event subscription-related action for an event indicative of whether a terminal device is served in an area of interest, AOI, the method comprising:
receiving a first event subscription request for the terminal device, the first event subscription request indicating one or more network entities;
determining if one of the one or more network entities is registered or registering as a serving network entity for the terminal device; and
triggering, dependent on a result of the determination, at least one event subscription-related action for an event indicative of whether a terminal device is served in the AOI.

37. (canceled)

38. An apparatus for triggering an event subscription-related action for an event indicative of whether a terminal device is served in an area of interest, AOI, the apparatus being configured to be comprised in a core network domain of a mobile communication system and adapted configured to:
receive a first event subscription request for the terminal device, the first event subscription request indicating one or more network entities;
determine if one of the one or more network entities is registered or registering as a serving network entity for the terminal device; and
trigger dependent on a result of the determination, at least one event subscription-related action for an event indicative of whether a terminal device is served in the AOI.

39. The apparatus of claim 38, further configured to trigger storing of information indicated in the first event subscription request in association with subscriber data for the terminal device.

40. (canceled)

45. The method of claim 2, wherein the first event subscription request defines an applicability of the associated event subscription to the one or more network entities indicated in the first event subscription request.
